(19) United States
(12) Patent Application Publication
(10) Pub. No.: US 2011/0258124 A1
(43) Pub. Date: Oct. 20, 2011

(54) LEASE FINANCED ASSET TRACKING SYSTEM AND BUNDLED ASSET DOCUMENT GENERATOR

(75) Inventors: Joel R. Emmett, Lawrenceville, GA (US); John Hammond, Fayetteville, GA (US); Marianne D. Velker, Lilburn, GA (US)

(73) Assignee: BANK OF AMERICA CORPORATION, Charlotte, NC (US)

(21) Appl. No.: 12/762,770

(22) Filed: Apr. 19, 2010

(51) Int. Cl. G06Q 10/00; G06Q 40/00; G06Q 99/00; G06Q 30/00

(52) U.S. Cl. 705/80; 705/307

(57) ABSTRACT

Embodiments of the invention relate to systems, methods, and computer program products for an automated and electronic means for financial institution clients to manage and track the funding of leased assets and, specifically, the combining of like assets into leased asset bundles for the purpose of generating lease records that include a leased asset bundle. By bundling assets and creating corresponding lease reports that include a leased asset bundle, the process for funding approval is streamlined, in that, document communication, signature requirements and overall tracking of documentation is minimized. In addition, an ancillary benefit is afforded the financial institution such that the bundled assets can be syndicated to third parties as a single schedule document.

### FIELD

In general, embodiments of the invention relate to methods, systems, apparatus and computer program products for a lease management system and, more particularly, a lease financed asset tracking and bundled asset document generator application.

### BACKGROUND

One service that a financial institution provides to a large corporate client or the like is the ability to finance the leasing of assets, typically high dollar assets, such as equipment or the like. For example, a large corporate client may lease a large volume of tractors or other farm equipment and the financial institution will provide financing for the leases. In many instances, the delivery of such equipment to the corporate client is conducted over an extended period of time, for example, six months or longer. The extended period of time is warranted because in many instances the equipment is manufactured and/or assembled by multiple entities. For example, a vehicle's chassis may be procured from one entity, while other components may be procured from other entities. This multifaceted build approach means that the financing of the equipment requires multiple payments of various related invoices. In other instances, the financial institution provides the corporate client with financing for lower dollar assets generally having higher volume, such as financing of office equipment or the like.

In traditional lease financing the process is highly manual, labor intensive and requires an extensive amount of paperwork to be communicated from the financial institution to the client and from the client to the financial institution. This is because each asset being financed requires its own documentation. Thus, if the client is financing 1,000 pieces of equipment, a corresponding 1,000 lease reports are needed to document the financing of the equipment. In addition to the process requiring a high volume of paperwork, the manual aspect of the process means that the client must personally communicate with the financial institution to check the status of the funding of an asset, request lease financing reports, print invoices, notify the financial institution of changes in asset location or the like.

Therefore, a need exists to automate the process for receiving a lease financing request and related information from a client and for the client to track the progress of the financing. In addition, the desired process should allow for the client to run reports, generate schedule documents and otherwise manage the lease financing without or with limited intervention by the financial institution. Specifically, a need exists to reduce the volume of paperwork required for clients financing a large volume of assets. By reducing the volume of paperwork the overall process becomes less labor intensive and more efficient. In addition, the desired process should benefit clients that are lease financing high-end assets, as well as, those clients that may be lease financing assets of lesser value.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for automated entry of lease finance of assets and the subsequent automated tracking and management of the lease financing process. Specifically, the present invention provides for an automated means by which the client can assess the funding of assets, such as the dates for funding, execute lease financing reports and otherwise manage the lease financing process.

Moreover, the present invention provides for significantly reducing the volume of paperwork required in the lease financing system by determining assets of similar type and/or lease parameters and combining such assets under a single bundled-asset lease report. The single lease report is instrumental in limiting the volume of paperwork, in that, a client can provide a signature, either an actual or electronic, to the bundled-asset lease report that summarizes all of the assets as opposed to having to submit individual signed paperwork for each individual asset. From the client standpoint such consolidation of paperwork results in a less labor intensive and a more efficient lease financing process. In addition, an ancillary benefit is afforded to the financial institution, in that; the bundled assets are more readily conducive to being subsequently syndicated to a third party.

A method for generating lease records that include bundled assets, defines embodiments of the present invention. The method includes receiving, at a computing device, a plurality of client inputs that each identify a leased asset and include one or more leasing parameters. The method further includes determining, via a computing device processor, one or more leased asset bundles that each includes a plurality of the leased assets. The plurality of leased assets included in each of the one or more leased asset bundles are based on the one or more of the leasing parameters. Additionally, the method includes generating, via a computing device processor, one or more leasing records that each includes one of the leased asset bundles. In specific embodiments of the method, the leasing parameters include one or more of lease pricing or lease term.

In further specific embodiments of the method, the plurality of leased assets included in each of the one or more leased asset bundles are based on at least one common leasing parameter from among the one or more leasing parameters. In such embodiments the one or more leasing parameters include one or more of lease pricing or lease term.

In further specific embodiments of the method, the leasing parameters include lease pricing and lease term. In further such specific embodiments, the plurality of leased assets included in each of the one or more leased asset bundles are based on common asset category, common lease pricing and common lease term.

In other specific embodiments of the method, receiving further includes receiving, at the computing device, the plurality of client inputs that each identify a leased asset and include the one or more leasing parameters and a client division identifier. In such embodiments, the plurality of leased assets included in each of the one or more leased asset bundles are based on the one or more of the leasing parameters and the client division identifier. In further such embodiments the plurality of leased assets included in each of the one or more leased asset bundles are based on common asset category, common lease pricing, common lease term and common client division.

In still further embodiments the method includes communicating each leasing record to the client and receiving, from the client, a signed copy of each leasing record, wherein the signed copy consummates financing of all of the assets in the leased asset bundle. Moreover, in further embodiments the method includes offering the leased asset bundle for syndication to one or more third party investors.

A system for generating lease reports that include bundled assets provides for further embodiments of the method. The system utilizes a computing platform including a memory and at least one processor. The system additionally includes a leased asset input and tracking application stored in the memory, executable by the processor and configured to receive a plurality of client inputs that each identify a leased asset and include one or more leasing parameters, such as lease pricing, lease term or the like. Additionally, the system includes a leased asset bundler stored in the memory, executable by the processor and configured to determine one or more leased asset bundles that each includes a plurality of the leased assets. The plurality of leased assets included in each of the one or more leased asset bundles are based on one or more of the leasing parameters. In addition, the system includes a lease record generator stored in the memory, executable by the processor and configured to generate one or more leasing records that each includes one of the leased asset bundles.

In specific embodiments of the system, the lease asset bundler is further configured to determine the one or more leased asset bundles. The plurality of leased assets included in each of the one or more leased asset bundles are based on at least one common leasing parameter from among the one or more leasing parameters, such as lease pricing, lease term, asset category or the like.

In further specific embodiments of the system, the leasing parameters include lease pricing and lease term. In specific embodiments of the system, the plurality of leased assets included in each of the one or more leased asset bundles are based on common asset category, common lease pricing and common lease term.

In other specific embodiments of the system, the lease asset input and tracking application is further configured to receive the plurality of client inputs that each identify a leased asset and include the one or more leasing parameters and a client division identifier. In such embodiments, the plurality of leased assets included in each of the one or more leased asset bundles are based on one or more of the leasing parameters and the client division identifier. In further specific embodiments the plurality of leased assets included in each of the one or more leased asset bundles are based on common asset category, common lease pricing, common lease term and common client division.

In additional specific embodiments of the system, the lease record application is further configured to electronically communicate each leasing record to the client, wherein the client signs each licensing record to consummate financing of all assets in the leased asset bundle.

In other specific embodiments the system includes a leased asset syndication application stored in the memory, executable by the processor and configured to offer the leased asset bundle for syndication to one or more third party investors.

A computer program product including a computer-readable medium defines further embodiments of the invention. The computer-readable medium includes a first set of codes for causing a computer to receive a plurality of client inputs that each identify a leased asset and include one or more leasing parameters. The computer-readable medium additionally includes a second set of codes for causing a computer to determine one or more leased asset bundles that each includes a plurality of the leased assets. The plurality of leased assets included in each of the one or more leased asset bundles are based on one or more of the leasing parameters. Additionally, the computer-readable medium includes a third set of codes for causing a computer to generate one or more leasing records that each includes one of the leased asset bundles.

Thus, as described in greater detail below, present embodiments of the invention provide for automated entry of lease finance requests for assets and the automated tracking of the finance process by the client. In addition, present embodiments provide for determining client assets of a common type and/or having common lease parameters for the purpose of combining such assets under a single bundled-asset lease report that serves to greatly minimize the volume of paperwork and signatures required in the lease financing process.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of an apparatus for determining leased asset bundles and generating corresponding lease records, in accordance with embodiments of the present invention;

FIG. 2 is a more detailed block diagram of an apparatus for determining leased asset bundles and generating corresponding lease records, in accordance with embodiments of the present invention;

FIG. 3 is a flow diagram of a method for determining leased asset bundles and generating corresponding lease records, in accordance with embodiments of the present invention;

FIG. 4 is a screen shot diagram of a home page in a leased asset input and tracking application, according to certain embodiments of the invention;

FIG. 5 is a screen shot diagram of an asset information entry page in a leased asset input and tracking application, in accordance with an embodiment of the invention.

FIG. 6 is a screen shot diagram of another asset information entry page in a leased asset input and tracking application, in accordance with an embodiment of the invention.

FIG. 7 is a screen shot diagram of an asset funding page, in accordance with an embodiment of the invention.

FIG. 8 is a screen shot diagram of a pop-up window for adding a new funding vendor, in accordance with an embodiment of the invention.

FIG. 9 is a screen shot diagram of vendor information edit page, in accordance with an embodiment of the invention.

FIG. 10 is a screen shot diagram of a lease report generation page, in accordance with an embodiment of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a computing device, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, apparatus, systems, methods and computer program products are herein disclosed that provide for electronic client-entry and client-tracking of assets that are lease financed. Specifically, the present invention provides for an automated and electronic means by which the client can manage the funding of leased assets.

Moreover, apparatus, systems, methods and computer program products are herein described for determining assets that can combined into what is herein referred to as “asset bundles” and generating a single lease report that encompasses all of the assets included in the asset bundle. Bundling of assets is based on assets of common asset category, common leasing parameters, e.g., lease pricing, lease term or the like, and/or common corporate entity, such as a division, a subsidiary or the like. The bundling of assets, such that a single lease report can be generated, significantly reduces the amount of signature paperwork required in the lease financing process, making the overall process more efficient. Moreover, the financial institution benefits from bundling assets, in that, the asset bundles are more readily conducive to being syndicated to a third party.

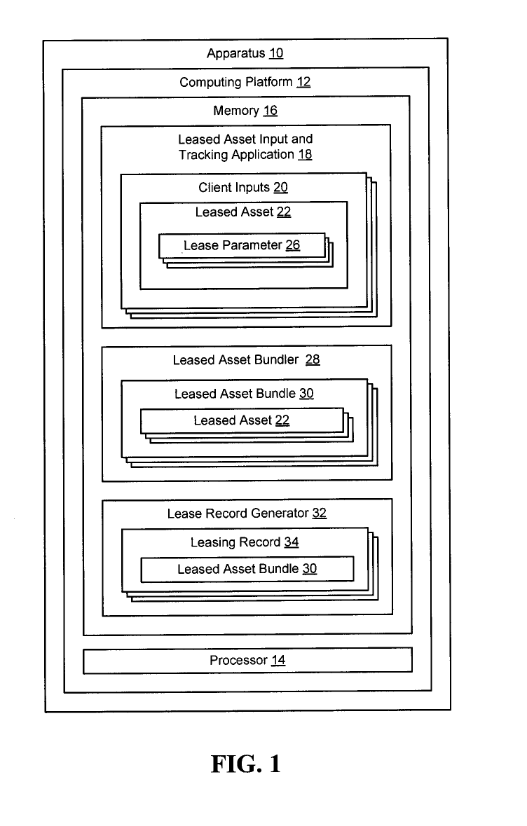

Referring to FIG. 1, shown is a high level schematic diagram of an apparatus 10 configured for determining asset bundles and generating corresponding lease reports that include an asset bundle; in accordance with embodiments of the present invention. The apparatus 10, which may comprise more than one computing device, includes a computing platform 12 having at least one processor 14 and a memory 16.

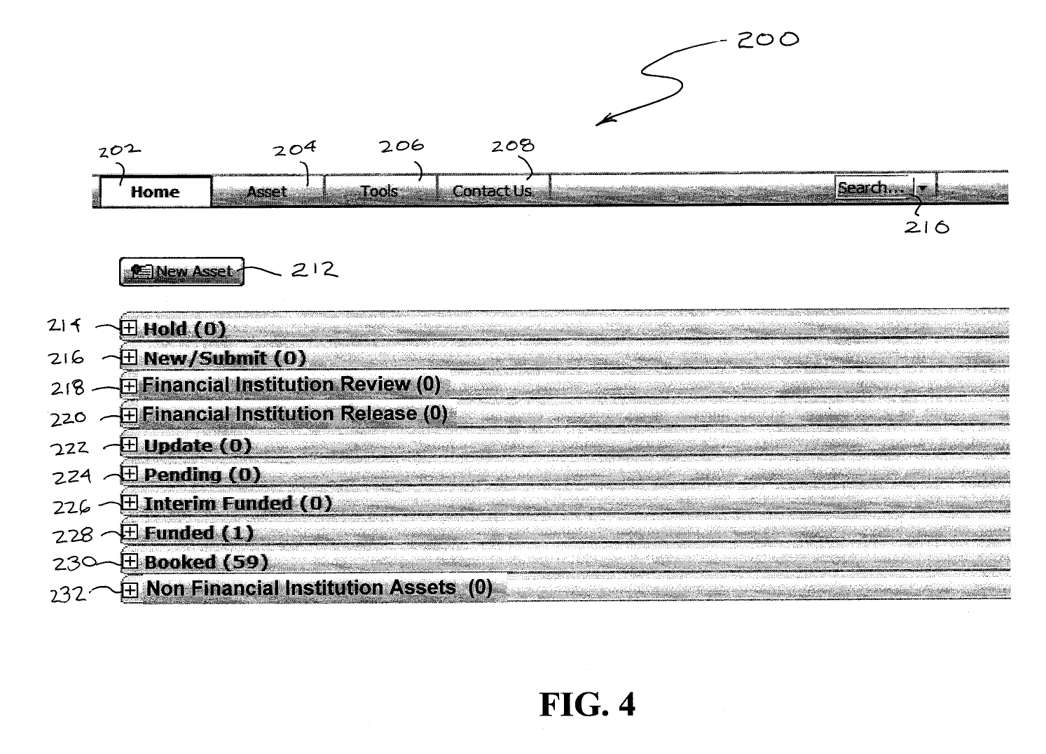

The memory 16 of apparatus 10 stores leased asset input and tracking application 18, which is characteristically implemented by a financial institution for the benefit of a client/customer that funds leased assets through the financial institution. In specific embodiments of the invention, asset input and tracking application 18 is a web-based application, accessible by the clients/customer. As previously noted, the leased asset input and tracking application may be especially suited to benefit clients that procure large ticket items, such as vehicles, industrial equipment and the like, as well as clients that procure medium ticket items, such as office equipment and the like. The leased asset input and tracking application may be configured such that it provides the client network access, via the Internet or another network, to a self-service asset input and tracking portal that allows the client to manage the overall asset funding process, including, but not limited to, entering funding requests, view current assets funded, downloading invoices, generating customized asset funding schedules, reports and the like. A specific example of such an asset input and tracking portal and corresponding web pages associated with such a portal are shown in FIG. 4-10 and discussed infra.

In specific embodiments of the invention, the leased asset input and tracking application 18 is configured to receive a plurality of client inputs 20 that define a leased asset 22 for which funding is being requested. Additionally, each client input 20 includes one or more leasing parameters 26. The leasing parameters 26 may include, but are not limited to, lease pricing, lease terms and the like. In specific embodiments of the invention, leasing parameters 26, such as asset category, lease pricing, lease term and the like may be preconfigured as parameter groups, such that selection of one parameter dictates selection of the other parameters. In other specific embodiments of the invention, leasing parameters 26 may be independently selected by the client. Moreover, in other embodiments, certain leasing parameters 26, for example, lease pricing and lease term, may be paired up such that selection of a lease price dictates a corresponding lease term and/or selection of a lease term dictates a corresponding lease price.

Memory 16 of apparatus 10 additionally includes leased asset bundler 28. Leased asset bundler 28 may be a stand-alone application or routine, as shown in FIG. 1, or it may be included as a sub-application, sub-routine within leased asset input and tracking application 18. The leased asset bundler 28 is executable by processor 14 and configured to automatically determine leased asset bundles 30 that each include a plurality of the leased assets 22 associated with the client inputs 20. The plurality of leased assets 22 included in each of the one or more leased asset bundles are based on an association between the one or more of the leasing parameters. Thus, according to specific embodiments of the invention, a leased asset bundle 30 includes leased assets 22 having one or more common leasing parameters. In a further specific embodiment of the invention, a leased asset bundle 30 includes leased assets 22 having a common asset category, a common lease term and a common lease pricing.

Further, memory 16 of apparatus 10 includes lease record generator 32. Lease record generator 32 may be a stand-alone application or routine, as shown in FIG. 1, or it may be included as a sub-application, sub-routine within leased asset input and tracking application 18. The lease record generator 32 is executable by processor 14 and configured to generate lease records 34 that each includes one of the leased asset bundles 30. By generating a comprehensive and unitary lease record 34 that includes all of the leased assets 22 in a leased asset bundle 30, the present invention provides efficiency to the overall lease funding process, by limiting the signatory paperwork required to be submitted by the client to finalize the funding of the associated bundled assets. As such communication and tracking of paperwork is streamlined. In addition, the signature required by the client may be an actual signature or the signature may be an electronic signature.

It should be noted that the leased asset bundler 28 may be implemented on as needed or on a scheduled basis. For example, in certain embodiments of the invention the leased asset bundler 28 may be implemented on a business daily basis, such that all client inputs 20 received during the business day are subjected to leased asset bundling. In this regard, it should be noted, and will be explained with more detail below in relation to FIGS. 4-10, that the leased asset input and tracking application 18 may be configured such that a client may enter a funding request and hold the request in the system prior to submitting the funding request (i.e., making the client input 20) to the financial institution for funding. Thus, in practice, a client may enter funding requests for assets throughout a specified period, such as a month, place the requests on hold until the end of the specified period and submit all of the funding requests (i.e., make the client inputs 20) at one specific time, insuring that all the funding requests are considered for inclusion in the following scheduled execution of the leased asset bundler 28.

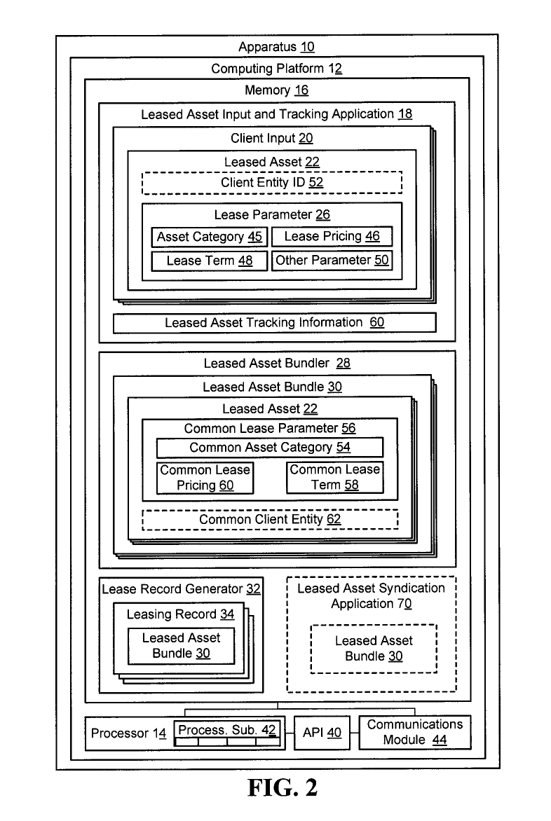

Referring to FIG. 2, shown is a more detailed block diagram of apparatus 10, configured for determining asset bundles and generating corresponding lease reports that include an asset bundle, according to embodiments of the present invention. In addition to providing greater detail, FIG. 2 highlights various alternate embodiments of the invention. The apparatus 10 may include one or more of any type of computerized device. The present apparatus and methods can accordingly be performed on any form of computing device.

The apparatus 10 includes computing platform 12 that can receive and execute routines and applications. Computing platform 12 includes memory 16, which may comprise volatile and non-volatile memory, such as read-only and/or random-access memory (RAM and ROM), EPROM, EEPROM, flash cards, or any memory common to computer platforms. Further, memory 16 may include one or more flash memory cells, or may be any secondary or tertiary storage device, such as magnetic media, optical media, tape, or soft or hard disk.

Further, computing platform 12 also includes processor 14, which may be an application-specific integrated circuit (“ASIC”), or other chipset, processor, logic circuit, or other data processing device. Processor 14 or other processor such as ASIC may execute an application programming interface (“API”) 40 that interfaces with any resident programs, leased asset input and tracking application 18, leased asset bundler 28, lease record generator 32, leased asset syndication application 60 or the like stored in the memory 16 of the apparatus 10.

Processor 14 may be configured to include various processing subsystems 42 embodied in hardware, firmware, software, and combinations thereof, that enable the functionality of apparatus 10 and the operability of the apparatus on a network. For example, processing subsystems 42 allow for initiating and maintaining communications and exchanging data with other networked devices. For the disclosed aspects, processing subsystems 42 of processor 14 may include any subsystem used in conjunction with leased asset input and tracking application 18, leased asset bundler 28, lease record generator 32, leased asset syndication application 60 or subcomponents or sub-modules thereof.

Computer platform 12 additionally includes communications module 44 embodied in hardware, firmware, software, and combinations thereof, that enables communications among the various components of the apparatus 10, as well as between the other devices in the electronic discovery system. Thus, communication module 44 may include the requisite hardware, firmware, software and/or combinations thereof for establishing a network communication connection.

As previously noted, the memory 16 of computing platform 12 stores leased asset input and tracking application 18 that is executable by the processor 14 and configured to receive a plurality of client inputs 20 that define a leased asset 22 for which funding is being requested. Additionally, each client input 20 includes one or more leasing parameters 26 and, optionally, a client entity identifier 52. The leasing parameters 26 may include, but are not limited to, asset category 45, lease pricing 46, lease term 48 and any other relevant leasing parameter 50. The client entity identifier 52 may be required in instances in which the client has multiple entities, such as divisions, subsidiaries or the like and all or a portion of the entities use the leased asset input and tracking application 18 to input asset funding requests and track asset funding

Memory 16 of apparatus 10 additionally includes leased asset bundler 28. The leased asset bundler 28 is executable by processor 14 and configured to automatically determine, based on leased asset submissions by the client, leased asset bundles 30 that each include a plurality of the leased assets 22 associated with the client inputs 20. The plurality of leased assets 22 included in each of the one or more leased asset bundles are based on an association between the one or more of the leasing parameters and, optionally, the client entity. Thus, according to specific embodiments of the invention, a leased asset bundle 30 includes leased assets 22 having a common asset category 54, one or more common leasing parameters 56, such as common lease term 58, common lease pricing 60 and optionally a common client entity 62.

Further, memory 16 of apparatus 10 includes lease record generator 32 that is executable by the processor 14 and configured to generate lease records 34 that each include one of the leased asset bundles 30. By generating a comprehensive and unitary lease record 34 that includes all of the leased assets 22 in a leased asset bundle 30, the present invention provides efficiency to the overall lease funding process, by limiting the signatory paperwork required to be submitted by the client to finalize the funding of the associated bundled assets. As previously noted, the system may be configured to allow for electronic signatures in lieu of actual signatures.

Leased asset input and tracking application 18 additionally provides access to leased asset tracking information 60 that provides the client with information to track assets that have been booked into the financial institution's account system. The assets tracked via leased asset tracking information 60 includes those entered by the client via a web-based, self-service leased asset tracking application 18, as well as, assets entered into the system by traditional documentation and internal financial institution processes. The leased asset tracking information 60 may be configured be the client to include an array of export layouts, including, but not limited to, a forecast by year of remaining lease payments, asset financial information, customizable invoice, asset description and the like.

Additionally, memory 16 of apparatus 10 may optionally include leased asset syndication application 70 executed by the processor 14 and configured to offer leased asset bundles 30 for syndication to third parties and/or orchestrate the syndication of asset bundles 30 to third parties.

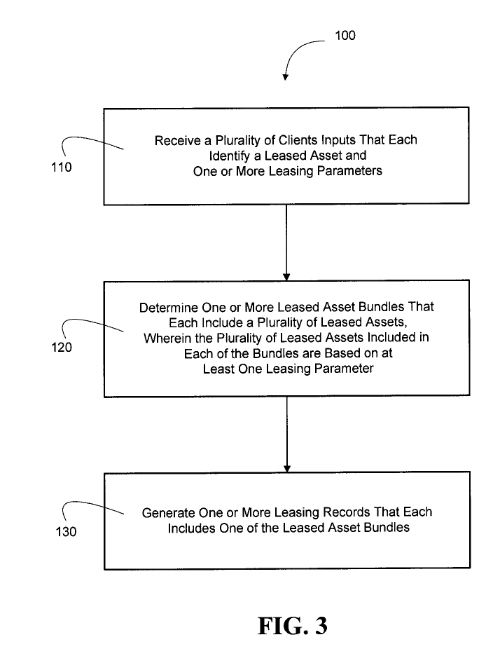

Referring to FIG. 3 a flow diagram of a method 100 for bundling assets and generating corresponding lease reports including an asset bundle is presented, in accordance with embodiments of the present invention At Event 110, a plurality of client inputs that each identify a leased asset requiring funding are received. Each client input includes one or more leasing parameters. The leasing parameters may include, but are not limited to, lease pricing, lease term and the like. Additionally, in optionally methods, the client input may include a client entity identifier, associated with a client division, subsidiary or the like.

At Event 120, one or more leased asset bundles are automatically determined that each include a plurality of leased assets. According to embodiments of the present invention the leased asset bundles are based on an association with the one or more lease parameters. In specific embodiments, the leased assets included in an asset bundles are based on one or more common lease parameters, such common lease pricing, common lease term and the like. In embodiments in which the client has multiple entities such as multiple divisions, business units, subsidiaries or the like, the leased assets included in an asset bundle may be based on common asset category, common lease pricing, common term and common client entity.

The plurality of client inputs (Event 110) are received prior to a designated time for determining leased asset bundles (Event 120). In one embodiment of the invention, client inputs may be received throughout a business day and leased asset bundles are determined at the end of the business day or prior to commencement of the next business day. It should be noted that a client may enter an asset funding request into the system and place the asset funding request on hold, prior to submitting the asset funding request to the financial institution. i.e., making a client input (Event 110) for processing, including potential bundling. In this regard, a client may accumulate in their hold queue numerous asset funding requests over a prolonged period of time, for example, a week or a month, prior to submitting the numerous asset funding requests to the financial institution.

At Event 130, one or more leasing reports are generated for the client. Each lease report includes one leased asset bundle. As such the multi-asset lease reports eliminate the need to generate individual lease reports for each individual leased asset. In generating lease reports that include asset bundles, less documentation communication is required, less documentation signatures on behalf of the client are required and less overall tracking of signature documentation is required; providing for a more streamlined and efficient process. An additional supplemental benefit of the asset bundles results from the bundles being potentially syndicated in total to third parties.

As previously noted, FIGS. 4-10 provide for exemplary web pages/screen shots presented in a leased asset input and tracking application. As previously noted, in specific embodiments of the invention, the leased asset input and tracking application is a web-based, self service application that provides for clients to enter lease funding requests, generate leasing schedules and/or reports and the like. One such leased asset input and tracking application is ExpressView™ provided by Bank of America Corporation of Charlotte, N.C. FIG. 4 provides a screen shot of a leased asset input and tracking portal home page 200, in accordance with embodiments of the present invention. Typically, a client accesses the portal by providing an appropriate web address to a suitable web browser and entering log-on credentials, such as user identification and passwords. Tabs running horizontally across the top of home page 200 indicate the current viewing category within the portal. Examples of viewing category tabs include home 202, asset 204, tools 206 and contact us 208. The client user can activate any one of the tabs to accesses corresponding web pages associated with the viewing category. The home page 200 additionally includes a search drop down menu 210 that provides the client the ability to search for assets by different search criteria.

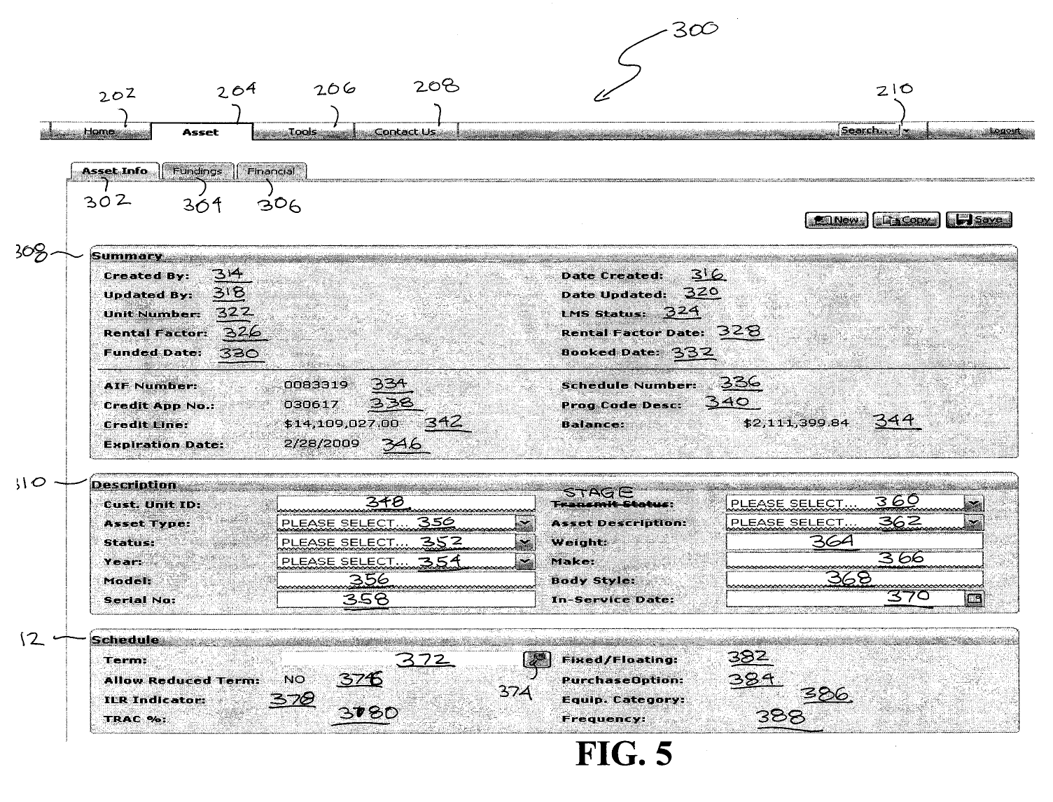

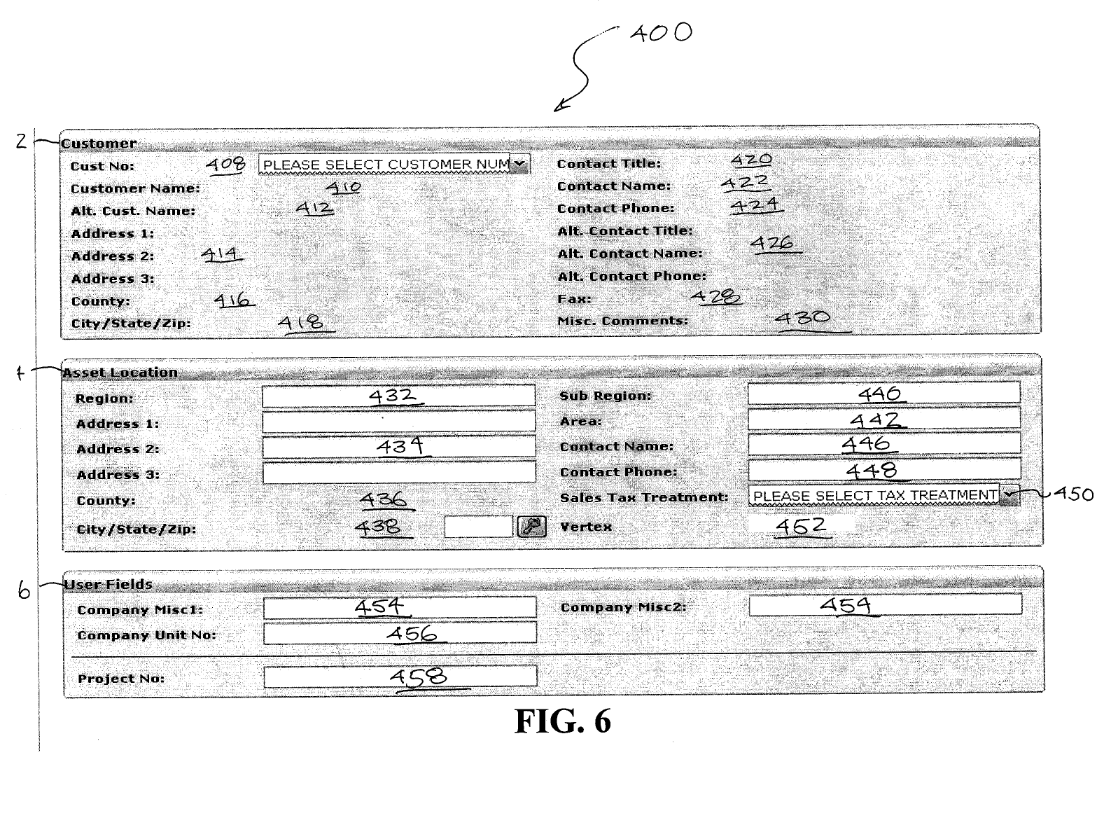

New asset key 212 is provided that upon client activation, accesses asset information input pages (FIGS. 5 and 6 discussed infra.). Additionally, the client may activate asset tab 204 to access asset information input pages.

Additionally, home page 200 provides for asset status indicators that can be activated, by clicking on or otherwise engaging the associated arrow key, to provide viewing of the assets associated with the asset status. The corresponding numeral in parenthesis indicates the number of assets currently associates with the asset status. In the illustrated home page 200, the asset status indicators include, hold status 214, new/submit status 216, financial institution review status 218, financial institution release 220, update 222, pending 224, interim funded 226, funded 228, booked 230 and inventory items, i.e., non-financial institution assets 232, which are not financed by the financial institution.

Referring to FIG. 5 asset information page/screen shot 300 is presented; in accordance with an embodiment of the present invention. The asset information page 300 may be accessed by activating the new asset key 212 provided for on the home page 200 (FIG. 4). The asset information page 300 is included under the asset tab 204 and specifically under the sub-tab asset info 302. Additional asset tab sub-tabs are provided for funding 304 and financial 306. The fundings 304 and financial 306 sub-tabs are illustrated as currently being inaccessible pending completion of the asset information portion. The asset information web page 300 includes summary fields 308, description entry fields 310 and schedule entry fields 312.

Summary fields 308 include information relevant to a specific asset that is displayable once the asset has been and information specific to the client. Information relevant to the asset includes a created by field 314 for displaying the name of the client associate that created the asset funding request; a date created field 316 for displaying the date the asset funding request is/was created; an updated field 318 for displaying the name of the client associate that updated the asset funding request, if applicable; and a date updated field 320 for displaying the date the asset funding is/was updated. The information relevant to the asset additionally includes a unit number field 322; an accounting system status field 324; a rental factor field 326; a rental factor date field 328; a funded date field 330 and a booked date field 332. Information specific to the client includes asset information number field 334; schedule number field 336; credit application number field 338; program code description field 340; credit line field 342; current credit balance field 344 and credit line expiration date field 346.

Description entry fields 310 include entries provided for by the client specific to the current asset being added. The description entry fields 310 includes customer unit identification field 348, which requires the client to assign a an asset-unique alpha-numeric value as the identification; asset type field 350, which provides a drop down window for the client to select a predetermined asset type (for example, automobiles, equipment, trucks over a prescribed weight, trucks under the prescribed weight and the like).

The description entry fields 310 additionally include status field 352, which provides a drop down window for the client to select a funding status option for the request. Funding status options may include, Single (one time funding) which results in generation of an Individual Lease Record (ILR), Multiple/Interim (multiple fundings to accommodate time-progress payment for, example, multiple component assets) which results in an Interim Funding Request (IFR) and Multiple/Final (if multiple, to designate this as the final submittal of the multiple fundings) which results in an ILR.

Additionally, the description entry fields 310 include year field 354, which provides for a drop down window for selecting the model year of the asset; model field 356 for entering the model number of the asset; serial number field 358 for entering the serial number of the asset; and stage field 360 which provides for a drop down window for selecting a stage option; including “Hold” for asset funding requests that will be pending subsequent submittal date, “New/Submit” for same day submission/client input, and “Non-Financial Institution Asset” for inventory listing within the system only. Description entry fields 310 also include asset description field 362 which provides a drop down menu for client selection of an equipment code or the like; weight field 364 for entering the weight of the asset; make field 366 for entering the manufacturer of the asset; body style field 368 for entering the body style, if applicable and in-service date field 370 which provides entry or calendar selection of the asset in-service date.

Schedule entry fields 312 include term field 372 that provides for a term/category key 374 that upon client activation provides for a client-selectable listing of terms and pricing per equipment/asset category. In such embodiments of the invention, client selection of a term/price and asset category grouping provides for the leasing parameters used to subsequently automatically determine asset bundles. The remaining fields in the schedule entry field 312 populate based on the selection of the term. The remaining fields include allow reduced term field 376; lease report indicator field 378; TRAC (Terminal Rental Adjustment Clause) percentage field 380; fixed/floating rate field 382; purchase option field 384; equipment category field 386 and frequency field 388. If the client selects a “floating” rate option, the client has the option of selecting a reduced term. In such embodiments, the reduced term/price and asset category grouping provides for the leasing parameters used to subsequently automatically determine asset bundles.

Turning the reader's attention to FIG. 6 an additional asset information page/screen shot 400 is presented; in accordance with an embodiment of the present invention. The additional asset information page 400 includes customer/client fields 402, asset location fields 404 and user fields 406. Customer/client fields 402 include customer number field 408 which provides for a drop down menu of selectable customer numbers. Each customer number corresponds to a customer/client entity, such as a division subsidiary or the like. In those embodiments of the invention in which the leased asset bundler determines asset bundles based on common client entity, the client's selection of the customer number defines the client entity. In addition, selection of the customer number will pre-populate the other customer client fields 402. The other customer/client fields 402 include customer/client name field 410; alternate customer/client name field 412, if applicable; customer address fields 414; customer/client county field 416; city/state/zip field 418; customer/client contact title field 420; customer/client contact name field 422; customer/client contact telephone number field 424; alternate customer/client contact fields 426; customer/client facsimile number field 428; and miscellaneous comments field 430.

The asset location fields 404 provide the client to input the location of the asset. The location of the asset is used for tax purposes. Since the location of the asset may change of time and such changes have tax implications, the client may access the leased asset input and tracking application throughout the lease period to update the asset location, as need be. The asset location fields 404 include region field 432; address fields 434; county field 436; city/state/zip field 438; sub-region field 440; area field 442; contact name field 446; contact telephone number field 448; sales tax treatment field 450, which provides for a drop down menu for the client to select tax exempt or non-tax exempt status; and vertex code field 452.

The user fields 406 are internal data fields for the benefit of the client and the information included within is not relied upon by the financial institution. While the embodiment shown is limited to four fields, other embodiments may be configured to include more or less user fields 406 as dictated by the client. In the illustrated embodiment, user fields 406 include company miscellaneous fields 454; company unit number field 456; project number field 458. Other fields may include cost center, purchase order number, release number and the like

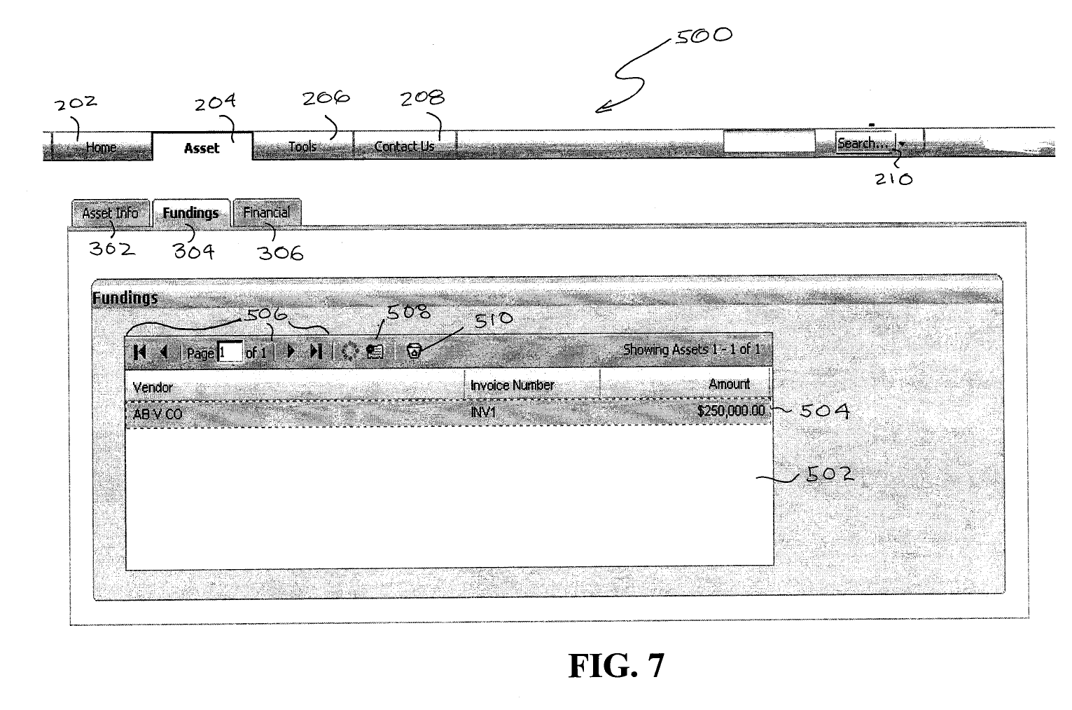

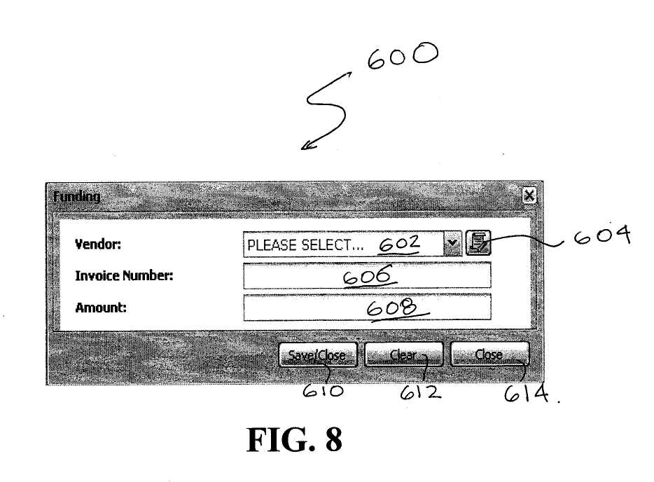

Referring to FIG. 7 a funding screen shot/page 500 is presented; in accordance with embodiments of the present invention. The funding page 500 may be accessed by activating asset tab 204 and the funding sub-tab 304. The funding page 500 provides for a funding listing window 502 that displays entries for currently funded assets. In the illustrated embodiment of FIG. 7, one funding entry 504 is shown in funding listing window 502. The funding entry 504 provides the name of the vendor/supplier, the invoice number and the amount of the invoice. Each entry in the listing may be activated, such as by mouse action or the like, to provide further details related to the funding, including specific information on the asset. Funding page 500 additionally includes a page scrolling area 506 for scrolling through multiple pages of funding entries; an add new funding key 508 that upon activation displays a new funding window (shown in FIG. 8) for adding new funding requests; and a deletion key 510 for deleting selected entries from the funding page 500.

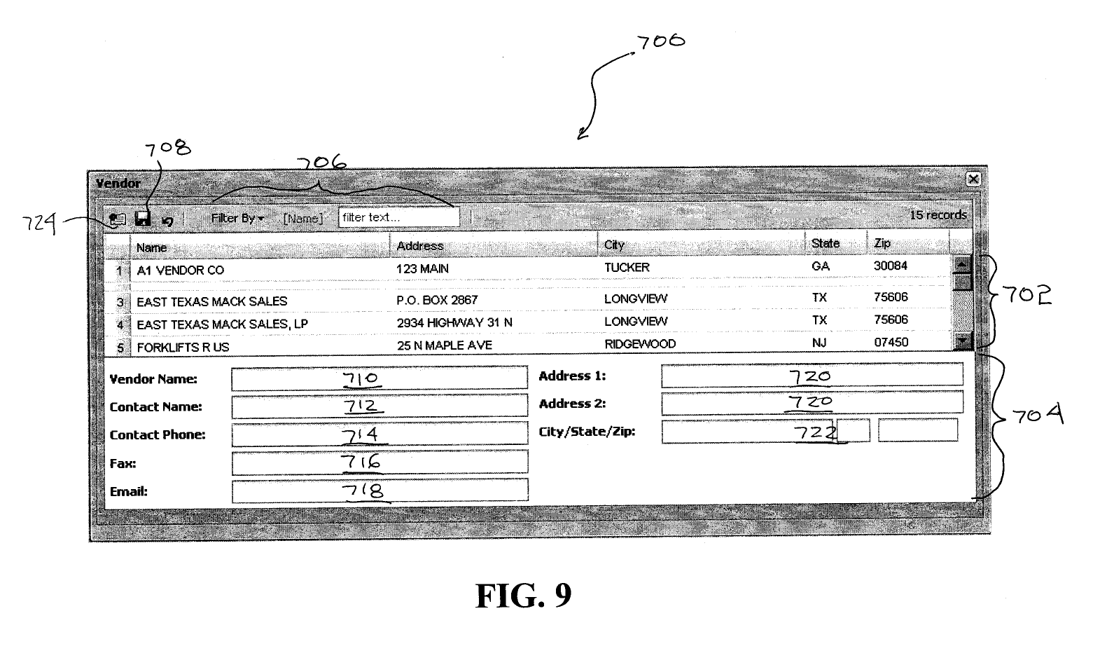

As noted, FIG. 8 depicts the funding request pop-up window/page 600 that is accessible by the client through activation of the new funding key 508 displayed on the funding page 500. The funding request page 600 includes vendor/supplier entry field 602, which provides for a drop down menu for the client to select from previously inputted vendors/suppliers. If the vendor/supplier that is to be entered in the funding request has not been previously entered, the client activates vendor input key 604 which provides for display of vendor page 700, shown in FIG. 9. In addition to adding a new vendor, vendor input key 604 may be activated by the client to edit the information related to a previously entered vendor. The funding request page 600 additionally includes invoice number entry field 606 and invoice amount entry field 608. Upon selecting the vendor and entering the invoice number and amount, the client activates save/close key 610 to save the funding request, create a funding record and attach the funding record to the asset record. Clear key 612 may be activated to clear the entries in the invoice number field 606 and invoice amount field 608 and close key 614 may be activated to close the funding request page 600.

Referring to FIG. 9 the vendor page 700 is depicted that provides for entering new vendors and/or editing information pertaining to previously entered vendors. The vendor page 700 includes scrollable vendor listing window 702 that allows for the client to select a vendor from the window and, upon vendor selection, display the current vendor information in the vendor information fields 704. The name, address, city, state and zip headings in the vendor listing window may be activated by sort the vendor listings in numerical or alphabetic order according to the selected heading. In addition, filter mechanism 706 provides for filtering/searching the vendor listings according to selected filter criteria and inputted filter/search text. Once a vendor from the vendor listing has been chosen and the related information displayed in the vendor information fields 704, the client may edit the information and, upon completion of the edit, activate the save key 708 to update the vendor information.

Additionally, vendor page 700 provides for entering new vendors by making entries in the vendor information fields 704. The vendor information fields include vendor name field 710; vendor contact name field 712; vendor contact telephone number field 714; vendor facsimile number field 716; vendor electronic mail address filed 718; vendor address fields 720; and city/state/zip fields 722. Upon completing entries in the vendor information fields, the client activates ne vendor key 724 to save the new vendor information as a listing in the client's vendor list.

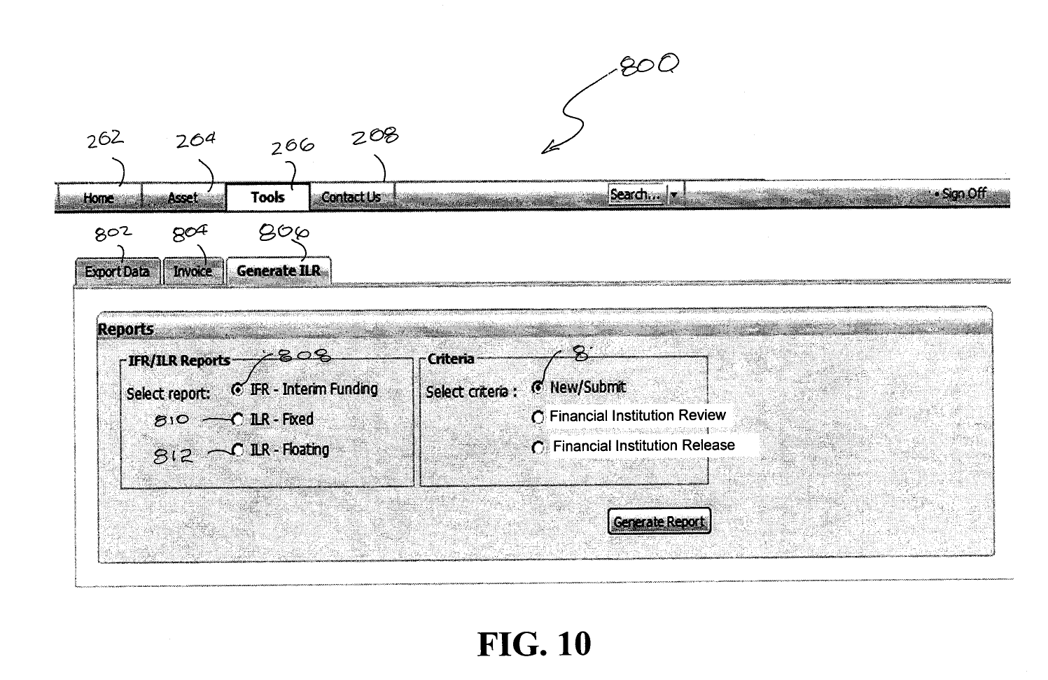

Referring to FIG. 10 a lease report generation page 800 is depicted; in accordance with embodiments of the present invention. The lease report generation page 800 is accessible from the tools 206 and the generate lease report sub-tab 806. Tools tab 206 additionally provides for export data sub-tab 802 and invoice sub-tab 804. The lease report generation page provides for the client to select a report type and report criteria. Lease report type selections include interim funding report selection 808; individual lease report-fixed selection 810 and individual lease report—floating selection 812. The interim funding report is implemented for multi-component assets or assets requiring multiple interim funding. In general, interim funding requests are not subject to subsequent asset bundling by the financial institution. Individual lease report—fixed provides for a lease report in which the assets are funded based on fixed interest rate and individual lease report—floating provides for a lease report in which the assets are funded based on a floating interest rate. In accordance with present embodiments, either type of individual lease report is subject to asset bundling.

The report criteria selections include new/submit selection 814; financial institution review 816; and financial institution release 818. The new/submit selection 814 is customarily the selection made by the client to submit the asset funding requests and generate an associated report. The financial institution review 816 and financial institution release 818 are validation processes conducted by the financial institution. Once the client has made appropriate report and criteria selections, the generate report key 818 is activated to initiate generation of the selected report type. For individual lease reports, a schedule number is assigned and asset bundling will occur in accordance with previously discussed embodiments of the invention. In accordance with specific embodiments assets will be bundled based on common asset category, and/or common term, and/or common pricing and/or common client entity. Once the lease report, including the asset bundle has been generated, the client reviews and prints the report and submits a signed report, along with invoices and supporting documentation to the financial institution to finalize the asset funding request.

Thus, present embodiments herein disclosed provide for an automated and electronic means for a financial institution client to manage the funding of leased assets and, specifically, embodiments provide for combining of like assets into leased asset bundles for the purpose of generating lease records that include a leased asset bundle. By bundling assets and creating corresponding lease reports that include a leased asset bundle, the process for funding approval is streamlined, in that, document communication, signature requirements and overall tracking of documentation is minimized. In addition, an ancillary benefit is afforded the financial institution such that the bundled assets can be syndicated to third parties as a single schedule document.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for generating lease records that include bundled assets, the method comprising:
receiving, at a computing device, a plurality of client inputs that each identify a leased asset and include one or more leasing parameters;
determining, via a computing device processor, one or more leased asset bundles that each include a plurality of the leased assets, wherein the plurality of leased assets included in each of the one or more leased asset bundles are based on one or more of the leasing parameters; and
generating, via a computing device processor, one or more leasing records that each include one of the leased asset bundles.

2. The method of claim 1, wherein receiving further comprises receiving, at the computing device, the plurality of client inputs that each identify a leased asset and include one or more leasing parameters, wherein the leasing parameters include one or more of asset category, lease pricing or lease term.

3. The method of claim 1, wherein determining further comprises determining, via the computing device processor, the one or more leased asset bundles, wherein the plurality of leased assets included in each of the one or more leased asset bundles are based on at least one common leasing parameter from among the one or more leasing parameters.

4. The method of claim 3, wherein determining further comprises determining, via the computer device processor, the one or more lease asset bundles, wherein the one or more leasing parameters include one or more of asset category, lease pricing or lease term.

5. The method of claim 1, wherein receiving further comprises receiving, at the computing device, the plurality of client inputs that each identify a leased asset and a plurality of leasing parameters, wherein the leasing parameters include asset category, lease pricing and lease term.

6. The method of claim 5, wherein determining further comprises determining, via the computing device processor, the one or more leased asset bundles, wherein the plurality of leased assets included in each of the one or more leased asset bundles are based on common asset category, common lease pricing and common lease term.

7. The method of claim 1, wherein receiving further comprises receiving, at the computing device, the plurality of client inputs that each identify a leased asset and include the one or more leasing parameters and a client division identifier.

8. The method of claim 7, wherein determining further comprises determining, via the computing device processor, the one or more leased asset bundles that each include a plurality of the leased assets, wherein the plurality of leased assets included in each of the one or more leased asset bundles are based on one or more of the leasing parameters and the client division identifier.

9. The method of claim 7, wherein receiving further comprises receiving, at the computing device, the plurality of client inputs that each identify a leased asset and include a plurality of leasing parameters and the client division identifier, wherein the leasing parameters include asset category, lease pricing and lease term.

10. The method of claim 9, wherein determining further comprises determining, via the computing device processor, the one or more leased asset bundles, wherein the plurality of leased assets included in each of the one or more leased asset bundles are based on common asset category, common lease pricing, common lease term and common client division.

11. The method of claim 1, further comprising receiving, from the client, a signed copy of each leasing record, wherein the signed copy consummates financing of all of the assets in the leased asset bundle.

12. The method of claim 11, wherein receiving further comprises, receiving, from the client one of an actual signed copy of the leasing record or an electronically signed copy of the leasing record.

13. The method of claim 1, further comprising syndicating the leased asset bundle to a third party investor.

14. A system for generating lease reports that include bundled assets, the system comprising,
a computing platform including a memory and at least one processor;
a leased asset input and tracking application stored in the memory, executable by the processor and configured to receive a plurality of client inputs that each identify a leased asset and include one or more leasing parameters;
a leased asset bundler stored in the memory, executable by the processor and configured to determine one or more leased asset bundles that each include a plurality of the leased assets, wherein the plurality of leased assets included in each of the one or more leased asset bundles are based on one or more of the leasing parameters; and
a lease record generator stored in the memory, executable by the processor and configured to generate one or more leasing records that each include one of the leased asset bundles.

15. The system of claim 14, wherein the leased asset input and tracking application is further configured to receive the plurality of client inputs that each identify a leased asset and include the one or more leasing parameters, wherein the leasing parameters include one or more of asset category, lease pricing or lease term.

16. The system of claim 14, wherein the lease asset bundler is further configured to determine the one or more leased asset bundles, wherein the plurality of leased assets included in each of the one or more leased asset bundles are based on at least one common leasing parameter from among the one or more leasing parameters.

17. The system of claim 16, wherein the lease asset bundler is further configured to determine the one or more lease asset bundles, wherein the one or more leasing parameters include one or more of lease pricing or lease term.

18. The system of claim 14, wherein the lease asset input and tracking application is further configured to receive the plurality of client inputs that each identify a leased asset and include a plurality of leasing parameters, wherein the leasing parameters include, asset category lease pricing and lease term.

19. The system of claim 18, wherein the lease asset bundler is further configured to determine the one or more leased asset bundles, wherein the plurality of leased assets included in each of the one or more leased asset bundles are based on common asset category, common lease pricing and common lease term.

20. The system of claim 14, wherein the lease asset input and tracking application is further configured to receive the plurality of client inputs that each include the asset category, the one or more leasing parameters and a client division identifier.

21. The system of claim 20, wherein the lease asset bundler is further configured to determine the one or more leased asset bundles that each include a plurality of the leased assets, wherein the plurality of leased assets included in each of the one or more leased asset bundles are based on one or more of the leasing parameters and the client division identifier.

22. The system of claim 21, wherein the lease asset input and tracking application is further configured to receive the plurality of client inputs that each include a plurality of leasing parameters and the client division identifier, wherein the leasing parameters include asset category, lease pricing and lease term.

23. The system of claim 22, wherein the lease asset bundler is further configured to determine the one or more leased asset bundles, wherein the plurality of leased assets included in each of the one or more leased asset bundles are based on common asset category, common lease pricing, common lease term and common client division.

24. The system of claim 14, wherein the lease record generator is further configured to electronically generate each leasing record for the client, wherein the client signs each licensing record to consummate financing of all assets in the leased asset bundle.

25. The system of claim 24, wherein the lease record generator is further configured to electronically generate each leasing record for the client, wherein the client signs each licensing record with an actual or electronic signature to consummate financing of all assets in the leased asset bundle.

26. The system of claim 14, further comprising a leased asset syndication application stored in the memory, executable by the processor and configured to syndicate the leased asset bundle to a third party investor.

27. A computer program product comprising:
a computer-readable medium comprising:
a first set of codes for causing a computer to receive a plurality of client inputs that each identify a leased asset and include one or more leasing parameters;
a second set of codes for causing a computer to determine one or more leased asset bundles that each include a plurality of the leased assets, wherein the plurality of leased assets included in each of the one or more leased asset bundles are based on one or more of the leasing parameters; and
a third set of codes for causing a computer to generate one or more leasing records that each includes one of the leased asset bundles.

28. The computer program product of claim 27, wherein the first set of codes is further configured to cause the computer to receive the plurality of client inputs that each identify a leased asset and include the one or more leasing parameters, wherein the leasing parameters include one or more lease pricing or lease term.

29. The computer program product of claim 27, wherein the second set of codes is further configured to cause the computer to determine the one or more leased asset bundles, wherein the plurality of leased assets included in each of the one or more leased asset bundles are based on at least one common leasing parameter from among the one or more leasing parameters.

30. The computer program product of claim 29, wherein the second set of codes is further configured to cause the computer to determine the one or more lease asset bundles, wherein the one or more leasing parameters include one or more of lease pricing or lease term.

31. The computer program product of claim 27, wherein the first set of codes is further configured to cause the computer to receive the plurality of client inputs that each include a plurality of leasing parameters, wherein the leasing parameters include asset category, lease pricing and lease term.

32. The computer program product of claim 31, wherein the second set of codes is further configured to cause the computer to determine the one or more leased asset bundles, wherein the plurality of leased assets included in each of the one or more leased asset bundles are based on common asset category, common lease pricing and common lease term.

33. The computer program product of claim 27, wherein the first set of codes is further configured to cause the computer to receive the plurality of client inputs that each identify a leased asset and include the one or more leasing parameters and a client division identifier.

34. The computer program product of claim 33, wherein the second set of codes is further configured to cause the computer to determine the one or more leased asset bundles that each include a plurality of the leased assets, wherein the plurality of leased assets included in each of the one or more leased asset bundles are based on one or more of the leasing parameters and the client division identifier.

35. The computer program product of claim 34, wherein the first set of codes is further configured to cause the computer to receive the plurality of client inputs that each identify a leased asset and include a plurality of leasing parameters and the client division identifier, wherein the leasing parameters include asset category, lease pricing and lease term.

36. The computer program product of claim 35, wherein the second set of codes is further configured to cause the computer to determine the one or more leased asset bundles, wherein the plurality of leased assets included in each of the one or more leased asset bundles are based on common asset category, common lease pricing, common lease term and common client division.

37. The computer program product of claim 27, further comprising a fourth set of codes for causing a computer to generate each leasing record for the client, wherein the client signs each licensing record to consummate financing of all assets in the leased asset bundle.

38. The computer program product of claim 27, further comprising a fourth set of codes for causing a computer to offer the leased asset bundle for syndication to a plurality of third party investors.
